(19) United States
(12) Patent Application Publication
(10) Pub. No.: US 2015/0143180 A1
(43) Pub. Date: May 21, 2015

(54) VALIDATING SOFTWARE CHARACTERISTICS

(71) Applicant: Microsoft Corporation, Redmond, WA (US)

(72) Inventors: Ryan A. Dawson, Redmond, WA (US); Dinesh B. Chandnani, Sammamish, WA (US); Li Xing, Clyde Hill, WA (US)

(73) Assignee: Microsoft Corporation, Redmond, WA (US)

(21) Appl. No.: 14/086,862

(22) Filed: Nov. 21, 2013

(51) Int. Cl. G06F 11/36

(52) U.S. Cl. CPC G06F 11/3612
USPC 714/38.1

(57) ABSTRACT

Aspects of the subject matter described herein relate to software validation. In aspects, code may be instrumented to generate certain records upon execution. The code may be further instrumented to generate start and stop records that correspond to the start and stop events of a scenario of a program. The start and stop event records allow correlation of the scenario with other records written to the log. With the correlation and appropriate instrumentation, a tool may determine performance, memory usage, functional correctness, and other characteristics of program at the granularity of the scenario.

### BACKGROUND

Software often suffers from memory and performance issues. For example, a software application may have a memory leak in which the software application requests memory but does not free the memory. Over time, this can lead to the software application consuming all or a significant portion of the memory available on a system. Similarly, the performance of a software application may degrade or vary significantly over time. These issues are frequently difficult to detect and fix.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

Briefly, aspects of the subject matter described herein relate to software validation. In aspects, code may be instrumented to generate certain records upon execution. The code may be further instrumented to generate start and stop records that correspond to the start and stop events of a scenario of a program. The start and stop event records allow correlation of the scenario with other records written to the log. With the correlation and appropriate instrumentation, a tool may determine performance, memory usage, functional correctness, and other characteristics of a program at the granularity of the scenario.

This Summary is provided to briefly identify some aspects of the subject matter that is further described below in the Detailed Description. This Summary is not intended to identify key or essential features of the claimed subject matter, nor is it intended to be used to limit the scope of the claimed subject matter.

The phrase “subject matter described herein” refers to subject matter described in the Detailed Description unless the context clearly indicates otherwise. The term “aspects” should be read as “at least one aspect.” Identifying aspects of the subject matter described in the Detailed Description is not intended to identify key or essential features of the claimed subject matter.

The aspects described above and other aspects of the subject matter described herein are illustrated by way of example and not limited in the accompanying figures in which like reference numerals indicate similar elements and in which:

### BRIEF DESCRIPTION OF THE DRAWINGS

FIG. 1 is a block diagram representing an exemplary computing environment into which aspects of the subject matter described herein may be incorporated;

FIG. 2 is a block diagram that generally represents exemplary components of a system configured in accordance with aspects of the subject matter described herein; and

FIG. 3 represents events that may have corresponding log entries in accordance with aspects of the subject matter described herein;

FIG. 4 is a graph that represents an exemplary analysis that may be performed across multiple iterations of a scenario in accordance with aspects of the subject matter described herein; and

FIGS. 5-6 are flow diagrams that generally represent exemplary actions that may occur in accordance with aspects of the subject matter described herein.

### DETAILED DESCRIPTION

### Definitions

As used herein, the term “includes” and its variants are to be read as open-ended terms that mean “includes, but is not limited to.” The term “or” is to be read as “and/or” unless the context clearly dictates otherwise. The term “based on” is to be read as “based at least in part on.” The terms “one embodiment” and “an embodiment” are to be read as “at least one embodiment.” The term “another embodiment” is to be read as “at least one other embodiment.”

As used herein, terms such as “a,” “an,” and “the” are inclusive of one or more of the indicated item or action. In particular, in the claims a reference to an item generally means at least one such item is present and a reference to an action means at least one instance of the action is performed.

Sometimes herein the terms “first”, “second”, “third” and so forth may be used. Without additional context, the use of these terms in the claims is not intended to imply an ordering but is rather used for identification purposes. For example, the phrases “first version” and “second version” do not necessarily mean that the first version is the very first version or was created before the second version or even that the first version is requested or operated on before the second version. Rather, these phrases are used to identify different versions.

Headings are for convenience only; information on a given topic may be found outside the section whose heading indicates that topic.

Other definitions, explicit and implicit, may be included below.

### Exemplary Operating Environment

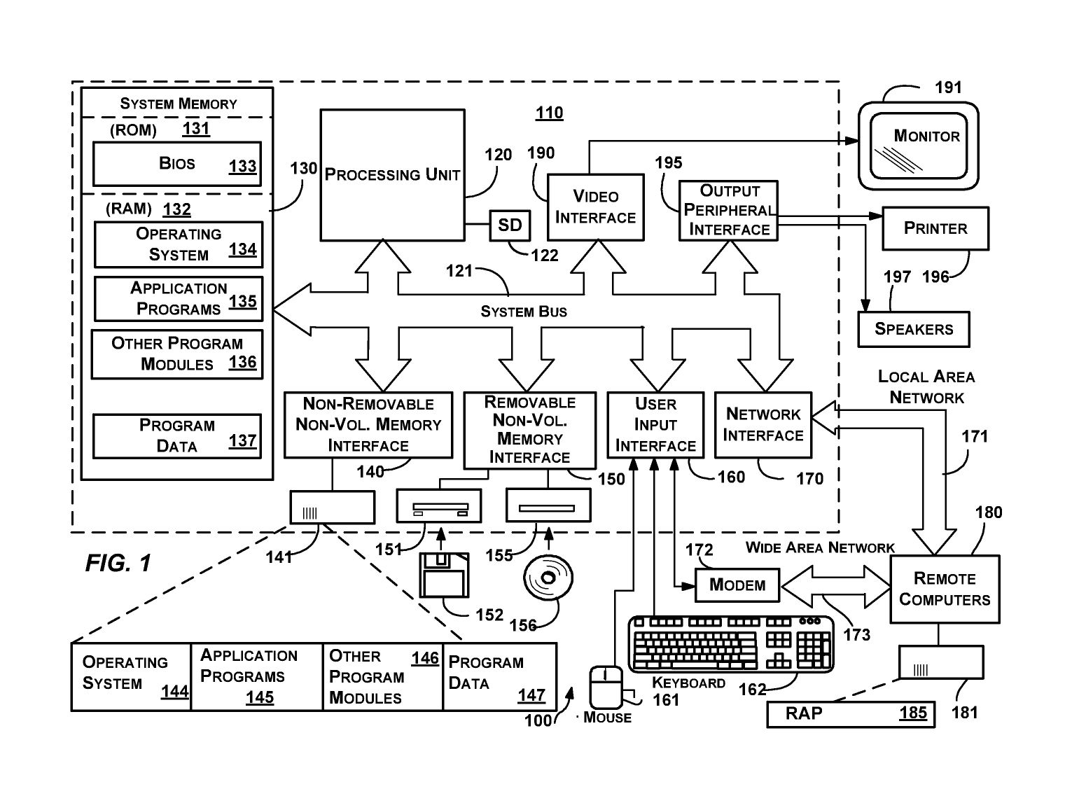

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well-known computing systems, environments, or configurations that may be suitable for use with aspects of the subject matter described herein comprise personal computers, server computers—whether on bare metal or as virtual machines—, hand-held or laptop devices, multiprocessor systems, microcontroller-based systems, set-top boxes, programmable and non-programmable consumer electronics, network PCs, minicomputers, mainframe computers, personal digital assistants (PDAs), gaming devices, printers, appliances including set-top, media center, or other appliances, automobile-embedded or attached computing devices, other mobile devices, phone devices including cell phones, wireless phones, and wired phones, distributed computing environments that include any of the above systems or devices, and the like. While various embodiments may be limited to one or more of the above devices, the term computer is intended to cover the devices above unless otherwise indicated.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Alternatively, or in addition, the functionality described herein may be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), and the like.

With reference to FIG. 1, an exemplary system for implementing aspects of the subject matter described herein includes a general-purpose computing device in the form of a computer 110. A computer may include any electronic device that is capable of executing an instruction. Components of the computer 110 may include a processing unit 120, a system memory 130, and one or more system buses (represented by system bus 121) that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, Peripheral Component Interconnect Extended (PCI-X) bus, Advanced Graphics Port (AGP), and PCI express (PCIe).

The processing unit 120 may be connected to a hardware security device 122. The security device 122 may store and be able to generate cryptographic keys that may be used to secure various aspects of the computer 110. In one embodiment, the security device 122 may comprise a Trusted Platform Module (TPM) chip, TPM Security Device, or the like.

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media.

Computer storage media includes both volatile and nonvolatile, removable and non-removable media implemented in any method or technology for storage of information such as computer-readable instructions, data structures, program modules, or other data. Computer storage media includes RAM, ROM, EEPROM, solid state storage, flash memory or other memory technology, CD-ROM, digital versatile discs (DVDs) or other optical disk storage, magnetic cassettes, magnetic tape, magnetic disk storage or other magnetic storage devices, or any other medium which can be used to store the desired information and which can be accessed by the computer 110. Computer storage media does not include communication media.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD ROM, DVD, or other optical media. Other removable/non-removable, volatile/nonvolatile computer storage media that can be used in the exemplary operating environment include magnetic tape cassettes, flash memory cards and other solid state storage devices, digital versatile discs, other optical discs, digital video tape, solid state RAM, solid state ROM, and the like. The hard disk drive 141 may be connected to the system bus 121 through the interface 140, and magnetic disk drive 151 and optical disc drive 155 may be connected to the system bus 121 by an interface for removable nonvolatile memory such as the interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies.

A user may enter commands and information into the computer 110 through input devices such as a keyboard 162 and pointing device 161, commonly referred to as a mouse, trackball, or touch pad. Other input devices (not shown) may include a microphone (e.g., for inputting voice or other audio), joystick, game pad, satellite dish, scanner, a touch-sensitive screen, a writing tablet, a camera (e.g., for inputting gestures or other visual input), or the like. These and other input devices are often connected to the processing unit 120 through a user input interface 160 that is coupled to the system bus, but may be connected by other interface and bus structures, such as a parallel port, game port or a universal serial bus (USB).

Through the use of one or more of the above-identified input devices a Natural User Interface (NUI) may be established. A NUI, may rely on speech recognition, touch and stylus recognition, gesture recognition both on screen and adjacent to the screen, air gestures, head and eye tracking, voice and speech, vision, touch, gestures, machine intelligence, and the like. Some exemplary NUI technology that may be employed to interact with a user include touch sensitive displays, voice and speech recognition, intention and goal understanding, motion gesture detection using depth cameras (such as stereoscopic camera systems, infrared camera systems, RGB camera systems, and combinations thereof), motion gesture detection using accelerometers/gyroscopes, facial recognition, 3D displays, head, eye, and gaze tracking, immersive augmented reality and virtual reality systems, as well as technologies for sensing brain activity using electric field sensing electrodes (EEG and related methods).

A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include phone networks, near field networks, and other networks. Such networking environments are commonplace in offices, enterprise-wide computer networks, intranets, and the Internet.

When used in a LAN networking environment, the computer 110 is connected to the LAN 171 through a network interface or adapter 170. When used in a WAN networking environment, the computer 110 may include a modem 172, network card, or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### Validating Software

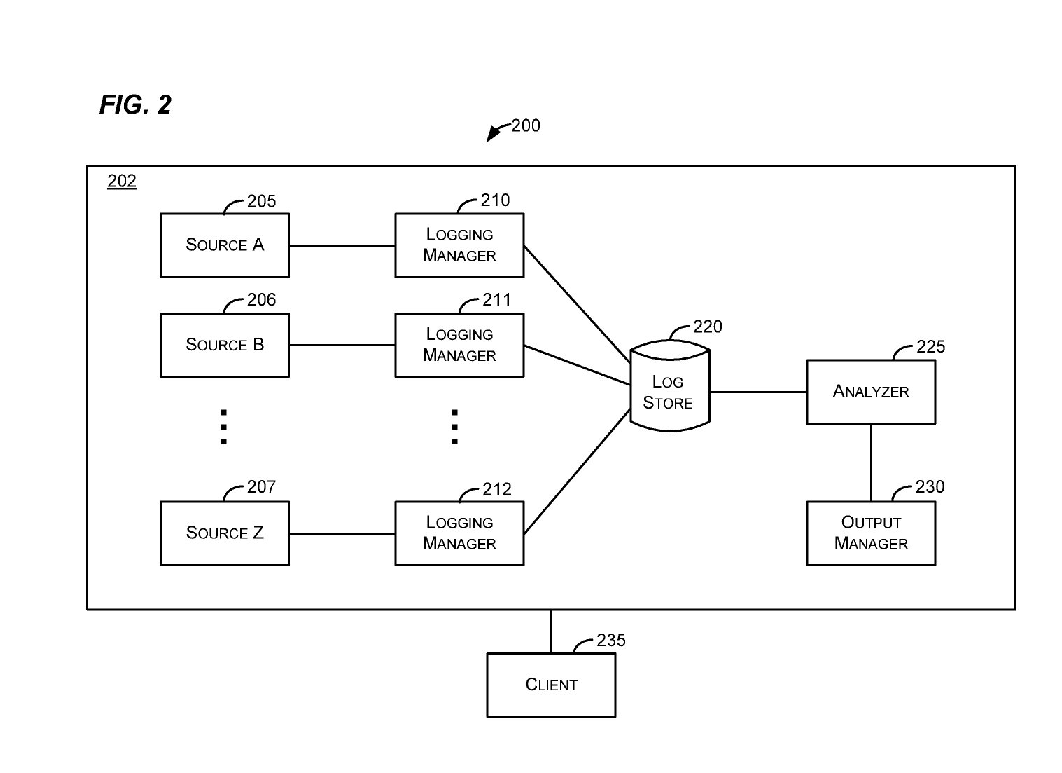

As mentioned previously, software may suffer from various issues. FIG. 2 is a block diagram that generally represents exemplary components of a system configured in accordance with aspects of the subject matter described herein. The components illustrated in FIG. 2 are exemplary and are not meant to be all-inclusive of components that may be needed or included. Furthermore, the number of components may differ in other embodiments without departing from the spirit or scope of aspects of the subject matter described herein. In some embodiments, the components described in conjunction with FIG. 2 may be included in other components (shown or not shown) or placed in subcomponents without departing from the spirit or scope of aspects of the subject matter described herein. In some embodiments, the components and/or functions described in conjunction with FIG. 2 may be distributed across multiple devices.

In some implementations, the components described in conjunction with FIG. 2 may be distributed throughout the cloud. The cloud is a term that is often used as a metaphor for the Internet. It draws on the idea that computation, software, data access, storage, and other resources may be provided by entities connected to the Internet without requiring users to know the location or other details about the computing infrastructure that delivers those resources.

As used herein, the term component may be read in alternate implementations to include hardware such as all or a portion of a device, a collection of one or more software modules or portions thereof, some combination of one or more software modules or portions thereof and one or more devices or portions thereof, or the like. In one implementation, a component may be implemented by structuring (e.g., programming) a processor (e.g., the processing unit 120 of FIG. 1) to perform one or more actions.

For example, the components illustrated in FIG. 2 may be implemented using one or more computing devices. Such devices may include, for example, personal computers, server computers, hand-held or laptop devices, multiprocessor systems, microcontroller-based systems, set-top boxes, programmable consumer electronics, network PCs, minicomputers, mainframe computers, cell phones, personal digital assistants (PDAs), gaming devices, printers, appliances including set-top, media center, or other appliances, automobile-embedded or attached computing devices, other mobile devices, distributed computing environments that include any of the above systems or devices, and the like.

An exemplary device that may be configured to implement one or more of the components of FIG. 2 comprises the computer 110 of FIG. 1.

In one implementation, a component may include or be represented by code. Code includes instructions that indicate actions a computer is to take. Code may also include data, resources, variables, definitions, relationships, associations, and the like that include information other than actions the computer is to take. For example, code may include images, Web pages, HTML, XML, other content, and the like.

Actions indicated in code may be encoded in a source code language, intermediate language, assembly language, binary language, another language, some combination of the above, and the like.

Code may be executed by a computer. When code is executed by a computer, this may be called a process. The term “process” and its variants as used herein may include one or more traditional processes, threads, components, libraries, objects that perform tasks, and the like. A process may be implemented in hardware, software, or a combination of hardware and software. In an embodiment, a process is any mechanism, however called, capable of or used in performing an action. A process may be distributed over multiple devices or a single device. Code may execute in user mode, kernel mode, some other mode, a combination of the above, or the like. A service is another name for a process that may be executed on one or more computers.

When the term “thread” is used herein, this term is to be read as a traditional software thread. A thread typically executes in the context of a process and multiple threads that execute in the context of a process may share state, memory, and other resources.

Although the terms “client” and “server” are sometimes used herein, it is to be understood, that a client may be implemented on a machine that has hardware and/or software that is typically associated with a server and that likewise, a server may be implemented on a machine that has hardware and/or software that is typically associated with a desktop, personal, or mobile computer. Furthermore, a client may at times act as a server and vice versa. At times, two or more entities that more frequently act as a client or server may concurrently be peers, servers, or clients. In an embodiment, a client and server may be implemented on the same physical machine.

Furthermore, as used herein, each of the terms “server” and “client” may refer to one or more physical or virtual entities, one or more processes executing on one or more physical or virtual entities, and the like. Thus, a server may include an actual physical node upon which one or more processes execute, a virtual node upon which one or more processes execute, a service executing on one or more nodes, a group of nodes that together provide a service, and the like.

For simplicity in explanation, some of the actions described below are described in a certain sequence. While the sequence may be followed for some implementations, there is no intention to limit other implementations to the particular sequence. Indeed, in some implementations, the actions described herein may be ordered in different ways and may proceed in parallel with each other.

Turning to FIG. 2, the system 200 may include an analysis system 202, a client 235, and other components (not shown). The analysis system 202 may include sources 205-207, logging managers 210-212, a memory 220, an analyzer 225, an output manager 230, and other components. In some implementations, there may be one or more than one of each of the components listed above.

The sources 205-207 provide log data for executed code. The sources 205-207 may correspond to different layers of a platform upon which an application executes. For example, a source may include instrumented code of a software application, an execution environment (sometimes referred to as a runtime), a rendering engine, system code (e.g., operating system code, file system code, and other system code), server code (e.g., code that responds to requests generated by the software application), portions of the application that were written in different languages, a host upon which the application executes, or the like.

The sources 205-207 may provide log data across multiple versions of one or more of the sources indicated above. For example, the source 205 may provide log data for an application executed in a first runtime version, the source 206 may provide log data for an application executed in a second runtime version, and so forth.

The logging managers 210-212 write logs to the memory 220. The logging managers 210-212 may include application programming interfaces (APIs) that the sources 205-207 call to provide log data. A logging manager may be included as part of a source (e.g., instrumented code of a source may write log records to the memory 220). A logging manager may receive log requests with a variety of data and may output log records of a fixed format (e.g., supplying and formatting fields as needed in a defined manner).

Logs may be stored in the memory 220. The memory 220 may include any storage media capable of storing data. The memory 220 may comprise volatile memory (e.g., RAM), nonvolatile memory (e.g., a hard disk), some combination of the above, and the like and may be distributed across multiple devices. The memory 220 may be external, internal, or include one or more components that are internal and one or more components that are external to computer(s) hosting the analysis system 202.

In one implementation, a log may include one or more records. Each record may include one or more data elements. A record may include one or more different data elements than another record. Some exemplary data elements that may be included in a log record include:

1. Timestamp: A timestamp may include a real time as obtained or maintained by a computer, a counter of a computer that corresponds to real time, a counter of a computer that increases over time but that does not increase proportionate to real time (e.g., each count may correspond to a different length of real time), a day, a month, a year, some combination of the above, or the like. If the system is capable, a high-precision timestamp may be used.

2. A process identifier. A process identifier may identify a process for which a log record was written.

3. A thread identifier. A thread identifier may identify a thread for which a log record was written.

4. A memory allocated value. A memory allocated value may indicate how much memory was allocated (delta or absolute) when the log record was created.

5. Objects allocated. The actual objects that are allocated may be output to a log. The memory allocated for each object may also be output to a log.

6. A scenario identifier. A scenario identifier identifies a testing scenario. A scenario may include one or more functions, events (e.g., clicking of a button or other user interface or system event), program statements, program steps, program actions, or the like. In one implementation, a scenario may be defined as all code executed between two selected statements in the code. The scenario may further be defined by process identifier and thread identifier as indicated herein. In one implementation, scenario records for a given scenario may include all log records that occur after a start scenario record and before a corresponding stop scenario record and that further include the process identifier and thread identifier identified by the start scenario record

The term “function” as used herein may be thought of as a portion of code that performs one or more tasks. Although a function may include a block of code that returns data, it is not limited to blocks of code that return data. A function may also perform a specific task without returning any data. Furthermore, a function may or may not have input parameters. A function may include a subroutine, a subprogram, a procedure, method, routine, or the like.

A testing scenario may be chosen to correspond to an end-user experience. For example, a testing scenario may be chosen to correspond to a user clicking a back button in a Web browser, a user clicking a save button of an application, a user gesturing on a touch-sensitive surface, a user scrolling through a document, or any other user interaction.

7. A start identifier. A start identifier may be used to indicate a start of a scenario.

8. A stop identifier. A stop identifier may be used to indicate an end of a scenario.

9. A call stack that exists when a logging statement occurs.

10. Values and names of one or more local variables that exist when a logging statement occurs.

11. Values and names of one or more global variables available when a logging statement occurs.

12. Hints as described below.

13. Whether a test scenario passed.

A configuration option may allow selection of what data is placed in a log record. For example, an option may indicate minimalistic logging, maximal logging, normal logging, a list of fields to log, or the like.

The examples above are not intended to be all-inclusive or exhaustive. Indeed, based on the teachings herein, those skilled in the art may recognize other data that may be logged without departing from the spirit or scope of aspects of the subject matter described herein.

Log records from multiple sources may be intermingled in the memory 220. In particular, log records from multiple processes and/or multiple threads may be written in the memory 220. Furthermore, although one memory is shown in FIG. 2, in other implementations, one or more logging managers may write logs to different log stores.

In one implementation, the analyzer 225 may perform the following exemplary steps to identify log records associated with a given scenario:

1. Scan the memory 220 for a start event record that includes an identifier associated with the scenario.

2. Select the next log record of the memory 220. In multi-processor/thread environments, if the log record includes the same process identifier and thread identifier as the start event record for the scenario, the log record is part of the scenario.

3. Repeat 2 until a stop event record is found that includes the identifier associated with the scenario. A stop event for the scenario may correspond to a selected event of a program (e.g., a function is called, returned from, a button is clicked or released, another event occurs, or the like) or to another scenario (e.g., the start or end event of another scenario occurs).

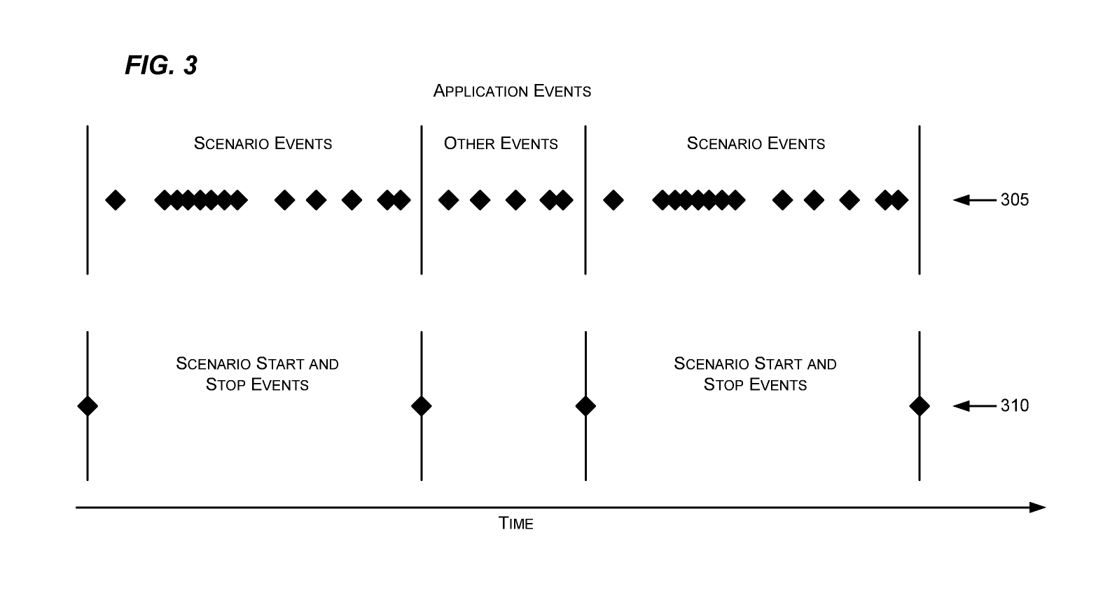

The actions above have the effect of correlating a scenario with log records that occur during the scenario. For example, referring to FIG. 3, logged application events (e.g., allocate memory, de-allocate memory, enter/exit function, and the like) are shown in the section 305 while the scenario start and stop events are shown in the section 310.

The start and stop events shown in section 310 define intervals of interest. Logged events that occur in the intervals may be used to determine performance, memory usage, and the like for repetitions of a scenario. Start and stop events may be logged each time a scenario occurs. The scenario start and stop events may correspond, for example, to clicking a button in a user interface.

In a single log, the log events shown in section 305 and section 310 may be combined. If the log events in sections 305 and 310 are in separate logs, the timestamp of each log event may be used to ensure that the events of section 305 fall between the events of section 310.

While the application event log records may be useful to show how much memory is being allocated with each instrumented allocation statement, without the start and stop events of section 310, the application event records may be hard or impossible to identify as corresponding to an identified user action (e.g., clicking a button) represented by the start and stop events of section 310. Logging the start and stop events of this scenario allows correlation between application events of interest and the scenario.

The logs for a scenario may be repeated multiple times in the memory 220. Differences across iterations may be used by the analyzer 225 to calculate statistics regarding the scenario. For example, data extracted from the log records written in each iteration of the scenario may be used to determine whether memory usage, performance, or some other execution characteristics are changing across iterations. To collect and analyze differences across iterations, steps 1-3 may be repeated until all log records have been examined.

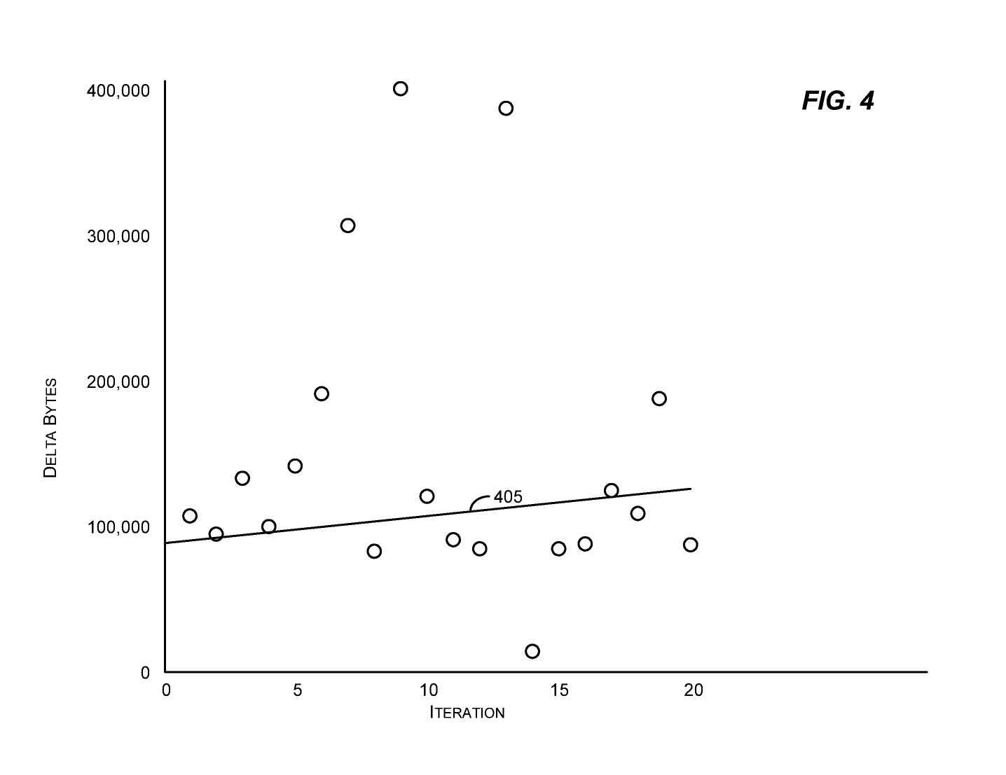

FIG. 4 is a graph that represents an exemplary analysis that may be performed across multiple iterations of a scenario. In the graph, iterations are shown along the horizontal axis while delta bytes allocated are shown along the vertical axis. The line 405 may be computed using a line fitting algorithm (e.g., least squares or some other algorithm that attempts to minimize error). The line 405 shows that the delta bytes allocated are increasing across the iterations. If this is not expected, this may indicate a memory leak.

The analyzer 225 may perform similar analysis on other characteristics written in a log. For example, the analyzer 225 may perform analysis on the duration the scenario across iterations.

As another example, the analyzer 225 may perform analysis on throughput of servicing client requests. For example, during execution, an application may make requests of a server component. A log may be written logging these requests and responses thereto. Afterwards, analysis may be performed to obtain statistics. Some exemplary throughput statistics include: maximum requests per time period, mean requests per time period, standard deviation, and trend slope.

Returning to FIG. 2, by evaluating the log files corresponding to multiple iterations of a scenario, the analyzer 225 may calculate various statistical values. Some exemplary statistical values include: maximum, minimum, mean, standard deviation, trend slope, and the like. Where data from multiple sources is available, statistical values for the scenario for each source may be calculated.

These statistical values may be outputted in a form suitable for viewing. For example, statistical values may be outputted in a Web page or other document that shows the statistical values.

Below is a table that shows some exemplary values for the bytes used by an application and the bytes used by a runtime across several iterations of a scenario:

| | | | Standard | |
|---|---|---|---|---|
| Component | Max Bytes | Mean Bytes | Deviation | Trend Slope |
| Application | 201,879,552 | 151,770,137 | 34,060,666 | 34,588.375 |
| Runtime | 89,812,992 | 56,588,662 | 18,145,031 | 18,858.354 |

A value may be outside of an expected range. For example, it may be expected that there will be no increase in memory consumption over multiple iterations of a scenario. In one implementation, a scenario may indicate or be associated with a hint that indicates expected behavior. If actual behavior falls outside of the expected behavior, the unexpected behavior may be highlighted (e.g., via bolding, coloring, background coloring, flashing, some other highlighting, or the like).

Some exemplary hints include:

1. That a scenario is expected to have a constant duration and memory growth when repeated.

2. That a scenario is expected to have a constant duration and no memory growth when repeated.

3. That a scenario is expected to have variable duration and no memory growth when repeated.

4. That a scenario is expected to have variable duration and variable memory growth.

5. That a scenario will use less than a specified amount of memory.

6. That a scenario will open the same number of files when repeated.

The examples above are not intended to be all-inclusive or exhaustive of what hints may be provided. Based on the teachings herein, those skilled in the art may recognize other hints that may be provided without departing from the spirit or scope of aspects of the subject matter described herein.

Below is a table that shows some exemplary values for duration for a scenario executed multiple times:

| | | | Max | Mean | |
|---|---|---|---|---|---|
| | | | Duration | Duration | |
| Scenario | Result | Iterations | (ms) | (ms) | StdDev |
| Weather | Pass | 20 | 3,591.464 | 3,514.593 | 27.3 |
| Scenario 1 | | | | | |
| Weather | Pass | 20 | 3,596.717 | 3,547.561 | 26.2 |
| Scenario 2 | | | | | |
| Weather | Pass | 20 | 3,626.427 | 3,584.363 | 26.7 |
| Scenario 3 | | | | | |

The table above includes a name of each scenario, the results (i.e., pass) of the scenarios, number of iterations, max duration in milliseconds, mean duration in milliseconds, and standard deviation. Other values (e.g., slope of trend line, memory usage statistics, or the like) may also be shown in the table without departing from the spirit or scope of aspects of the subject matter described herein.

There are other ways to obtain the records associated with a scenario. For example, with a query language, records not including the process identifier and thread identifier may be filtered out before processing a log. For example, a query language may be used to obtain a result set that has irrelevant records filtered out. After the irrelevant records are filtered out, each record in a result set may be related to the scenario. In this example, the following exemplary steps may be performed to identify log records associated with a given scenario:

1. Search the result set for a start event record.

2. Select the next record of the result set. This record is part of the scenario.

3. Repeat step 2 until a corresponding stop event record is found. In one implementation, a corresponding stop event record includes the same process identifier and thread identifier as the start event record.

4. Repeat steps 1-3 until all records of the result set have been examined.

There is no intention to limit the ways of correlating log records with a scenario to the examples above. Indeed, based on the teachings herein, those skilled in the art may recognize many other ways of obtaining the records associated with a scenario without departing from the spirit or scope of aspects of the subject matter described herein.

The output manager 230 may prepare reports that include data generated by the analyzer 225. For example, the output manager 230 may output graph data that indicates iteration, delta memory usage per iteration, and a trend line of memory usage over iterations of the test scenario (as illustrated in FIG. 4). As another example, the output manager may output table data that identifies at least the test scenario, whether the test scenario passed, a count of iterations of the test scenario, a maximum value, a mean value, a standard deviation value associated with the iterations, whether observed behavior deviates from expected behavior (as described previously), and other values (as described previously).

The client 235 may include any entity that interacts with the analysis system 202 to obtain output data. For example, the client 235 may be implemented as a Web browser that sends requests for analysis data to the analysis system 202 and receives Web pages in response. As another example, the client 235 may be implemented as proprietary software on a computer that requests analysis data from the analysis system 202 and outputs formatted data derived from the analysis system 202 on an output device such as a display.

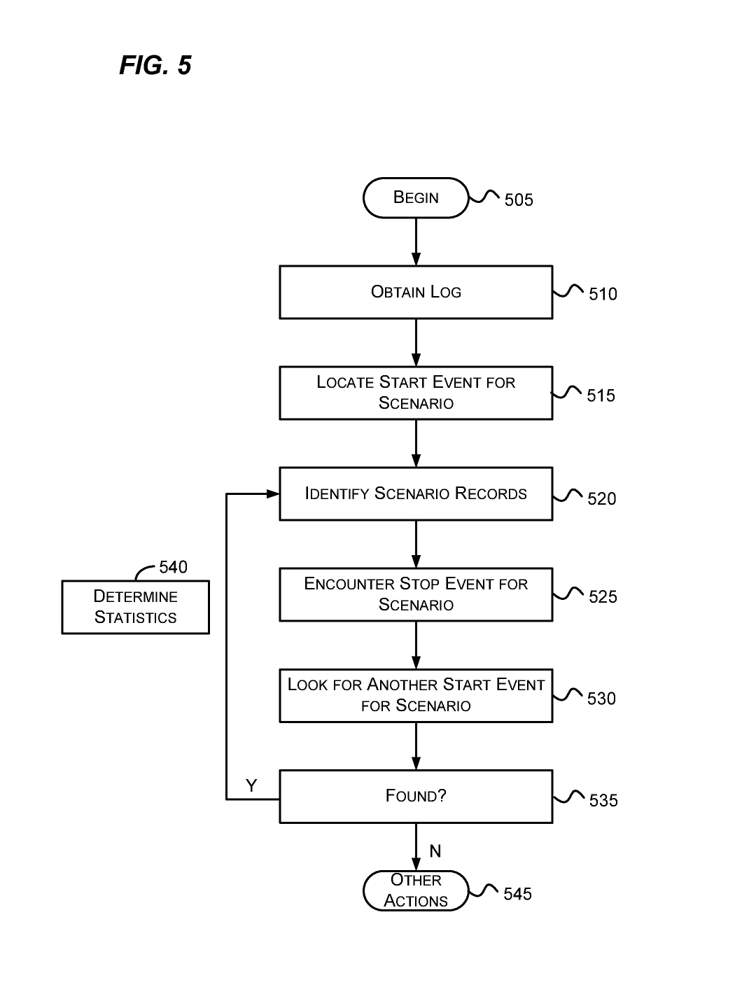

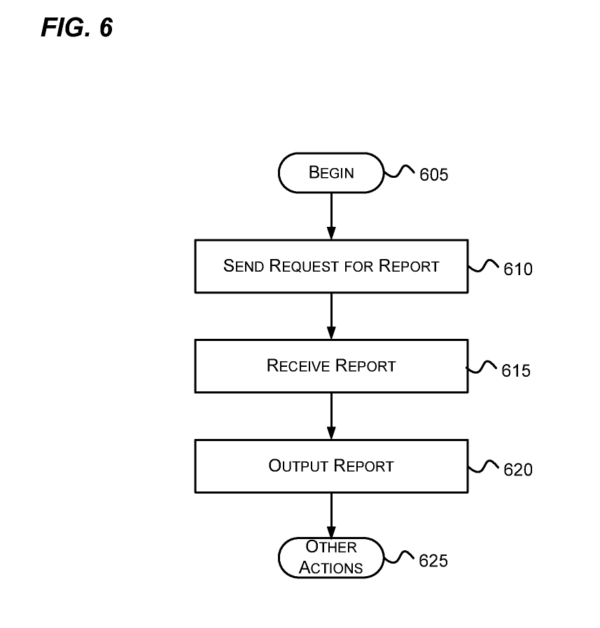

FIGS. 5-6 are flow diagrams that generally represent exemplary actions that may occur in accordance with aspects of the subject matter described herein. For simplicity of explanation, the methodology described in conjunction with FIGS. 5-6 is depicted and described as a series of acts. It is to be understood and appreciated that aspects of the subject matter described herein are not limited by the acts illustrated and/or by the order of acts. In one embodiment, the acts occur in an order as described below. In other embodiments, however, two or more of the acts may occur in parallel or in another order. In other embodiments, one or more of the actions may occur with other acts not presented and described herein. Furthermore, not all illustrated acts may be required to implement the methodology in accordance with aspects of the subject matter described herein. In addition, those skilled in the art will understand and appreciate that the methodology could alternatively be represented as a series of interrelated states via a state diagram or as events.

Turning to FIG. 5, at block 505, the actions begin. At block 510, a log is obtained. For example, referring to FIG. 2, the analyzer 225 may obtain a log from the memory 220. This log may have been previously generated by executing instrumented code.

At block 515, a start event record is located of a test scenario. The start event record may indicate, for example, an identifier and a start timestamp. For example, referring to FIG. 2, the analyzer 225 may search through a log included in the memory 220 to find a start event record for test scenario.

At block 520, scenario records within the log are identified. For example, referring to FIG. 5, the analyzer 225 obtains additional records from the memory 220. These additional records are scenario records that are generated after the start event record and before a stop event record of the scenario. Generation of a record occurs when a logging statement is encountered in executed code. Generation of a record may occur at a different time from when the record is actually written to a log. Where needed, a process identifier and/or a thread identifier identified by the start event record of a scenario may be used to identify scenario records.

At block 525, a stop event record for a scenario is located. The stop event record may indicate, for example, an identifier of the scenario and a stop timestamp. For example, referring to FIG. 2, the analyzer 225 may encounter a stop event record of a scenario as the analyzer 225 examines records of a log included in the memory 220.

At block 530, a search is performed for another start event record of the scenario. For example, referring to FIG. 2, the analyzer 225 may continue to obtain additional records of a log from the memory 220 until either another start event record for the scenario is found or until all the records of the log have been examined.

At block 535, if another start record is found, the actions continue at block 520; otherwise, the actions continue at block 545.

At block 540, statistics are determined for the scenario. Statistics may be determined and updated at any time during the processing of a log. For example, referring to FIG. 2, the analyzer 225 may update a statistics data structure as it examines log records from the memory 220.

At block 545, other actions, if any, are performed. Other actions may include, for example, preparing a report from the determined statistics. In preparation for preparing the report, a hint may be obtained that indicates expected behavior as the scenario repeats. In one example, the report may contain a graph such as the graph shown in FIG. 4. The scenario records may also be used for determining a count of how many times the test scenario was executed as indicated by the log.

Turning to FIG. 6, at block 605, the actions begin. At block 610, a request for an analysis report is sent. For example, referring to FIG. 2, the client 235 may send a request for an analysis report to the analysis system 202.

At block 615, the report is received. For example, referring to FIG. 2, the client 235 may receive a Web page from the analysis system 202. The Web page may include statistics, graphs, and other analysis data about one or more scenarios.

At block 620, the report may be outputted. For example, referring to FIG. 2, the client 235 may output the report to display or other output device of the client 235.

At block 625, other actions, if any, may be performed.

Although some of the discussion above has focused on performance and memory usage, the same concepts may also be applied to other characteristics. Some exemplary characteristics include how many files are opened, how many Web requests are made, how many functions are called, other characteristics, and the like.

As can be seen from the foregoing detailed description, aspects have been described related to software validation. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

What is claimed is:

1. A method implemented at least in part by a computer, the method comprising:
obtaining one or more logs generated in conjunction with executing code;
within the one or more logs, locating a start event record of a test scenario that is identified by an identifier, the start event record indicating a start timestamp and the identifier of the test scenario;
within the one or more logs, locating an stop event record of the test scenario, the stop event record indicating a stop timestamp and the identifier that identifies the test scenario;
identifying scenario records included in the one or more logs, the scenario records corresponding to log statements generated after the start event record and before the stop event record; and
using the scenario records to determine statistics regarding the test scenario, the statistics including at least one or more of: performance and memory usage.

2. The method of claim 1, wherein obtaining one or more logs comprises obtaining one or more logs generated by one or more of instrumented: application code, runtime code, rendering code, system code, and server code.

3. The method of claim 1, wherein identifying scenario records included in the one or more logs comprises finding records that have a process identifier and a thread identifier associated with the test scenario.

4. The method of claim 1, further comprising obtaining an analysis hint that indicates that the test scenario is expected to not have memory growth when repeated and highlighting output that indicates that memory consumption increased as the test scenario was repeated.

5. The method of claim 1, further comprising obtaining an analysis hint that indicates that the test scenario is expected to have constant duration when repeated and highlighting output that indicates that duration changed as the test scenario was repeated.

6. The method of claim 1, further comprising obtaining an analysis hint that indicates that the test scenario is expected to have variable duration and variable memory consumption when repeated and refraining from highlighting corresponding output that indicates variable duration and variable memory consumption as the test scenario was repeated.

7. The method of claim 1, wherein using the scenario records to determine statistics regarding the test scenario comprises using the scenario records to determine a duration of the test scenario.

8. The method of claim 1, wherein using the scenario records to determine statistics regarding the test scenario comprises using the scenario records to determine a delta of allocated memory before and after the test scenario.

9. The method of claim 1, wherein the statistics indicate delta allocated memory before and after the test scenario for two or more of: application memory, runtime memory, rendering memory, system memory, and server memory.

10. The method of claim 1, further comprising outputting a graph that shows iterations of the scenario on one axis and memory allocated on another axis.

11. The method of claim 1, wherein using the scenario records to determine statistics regarding the test scenario comprises using the scenario records to determine a count of how many times the test scenario was executed.

12. In a computing environment, a system, comprising:
a memory structured to store logs generated in conjunction with executing code; and
an analyzer coupled to the memory, the analyzer implemented via one or more processors, the analyzer structured to perform actions, the actions comprising:
obtaining one or more logs from the memory,
within the one or more logs, locating a start event record of a test scenario that is identified by an identifier, the start event record indicating a start timestamp and the identifier of the test scenario,
within the one or more logs, locating a stop event record of the test scenario, the stop event record indicating a stop timestamp and the identifier that identifies the test scenario,
identifying scenario records included in the one or more logs, the scenario records having timestamps after the start timestamp and before the stop timestamp, and
using the scenario records to determine whether memory usage for the scenario has followed a hint associated with the scenario.

13. The system of claim 12, wherein the analyzer being structured to use the scenario records to determine whether memory usage for the test scenario has followed a hint associated with the test scenario comprises the analyzer being structured to perform actions comprising tracking memory used over a plurality of repetitions of the test scenario.

14. The system of claim 12, wherein the analyzer is further structured to perform additional actions, comprising using the scenario records to determine whether duration of executing the scenario has followed another hint associated with the scenario.

15. The system of claim 14, wherein the analyzer being structured to use the scenario records to determine whether duration of executing the scenario has followed another hint associated with the scenario comprises the analyzer being structured to perform actions comprising tracking duration of the test scenario over a plurality of repetitions of the test scenario.

16. The system of claim 12, further comprising a plurality of sources structured to write the logs to the memory while executing code associated with the test scenario.

17. The system of claim 16, wherein the sources comprise one or more processors structured to execute instrumented code, the instrumented code including one or more of: application code, runtime code, rendering code, system code, and server code.

18. The system of claim 12, further comprising an output manager structured to output graph data that indicates iteration, delta memory usage per iteration, and a trend line of memory usage over iterations of the test scenario.

19. The system of claim 18, wherein the output manager is further structured to output table data that identifies at least the test scenario, whether the test scenario passed, a count of iterations of the test scenario, a maximum value, a mean value, and a standard deviation value associated with the iterations.

20. A computer storage medium having computer-executable instructions, which when executed perform actions, comprising:
sending a request for an analysis report to an analysis system that is structured to generate the analysis report by actions including:
obtaining one or more logs generated in conjunction with executing code of a test scenario,
locating a start event record and a stop event record within the logs, the start event record indicating a start timestamp of the test scenario, the stop event record indicating a stop timestamp of the test scenario,
identifying scenario records included in the one or more logs, the scenario records having timestamps after the start timestamp and before the stop timestamp,
using the scenario records to determine at least performance and memory usage statistics regarding the test scenario; and
from the analysis system, receiving a report that includes the statistics.
